(19) United States
(12) Patent Application Publication
(10) Pub. No.: US 2025/0277128 A1
(43) Pub. Date: Sep. 4, 2025

(54) ACRYLIC-OLEFIN HYBRID POLYMERS AND THEIR USES AS RUST PREVENTATIVES

(71) Applicant: The Lubrizol Corporation, Wickliffe, OH (US)

(72) Inventors: Amelia Hadler, Shaker Heights, OH (US); Ryan Weber, Solon, OH (US); David M. Nickerson, Concord Township, OH (US); Julie Keppler, Concord Township, OH (US); Vic Stanislawczyk, Strongsville, OH (US); David J. Smith, Amherst, OH (US); Britt A. Minch, Painesville Township, OH (US); Christopher Kabb, Lakewood, OH (US)

(73) Assignee: The Lubrizol Corporation, Wickliffe, OH (US)

(21) Appl. No.: 18/862,743

(22) PCT Filed: May 3, 2023
(86) PCT No.: PCT/US2023/020766

§ 371 Date: Nov. 4, 2024

Related U.S. Application Data
(60) Provisional application No. 63/338,943, filed on May 6, 2022.

(51) Int. Cl. C09D 123/24; C08F 210/14; C09D 5/08; C09D 7/43; C09D 7/45; C09D 7/63; C09D 7/65

(52) U.S. Cl. CPC C09D 123/24; C08F 210/14; C09D 5/08; C09D 7/43; C09D 7/45; C09D 7/63; C09D 7/65; C08F 2800/20

(57) ABSTRACT

Polymers having an acrylic-olefin backbone prepared from a monomer composition comprising at least one C₁₋₃₀ (meth)acrylic compound and at least on alpha-olefin having a chain length of at least 20 carbon atoms (a “C₂₀₊ α-olefin”). The resulting polymer has at least 30 wt % of the alpha-olefin incorporated therein. The polymers may be used in rust preventative compositions to reduce rust formation on items having metal components.

### FIELD OF THE INVENTION

The field of the disclosed technology is generally related to acrylic-olefin hybrid polymers for use as rust preventatives in coatings and metalworking fluids.

### BACKGROUND OF THE INVENTION

Many rust preventatives for heavy duty applications are based on high melt waxes. The most common waxes for heavy duty applications are either microcrystalline or petrolatum waxes. These wax feedstocks are closely tied to Group I refineries and can be under intense supply constraints when there are changes in the refining industry supply. Acrylate polymers are commonplace, however, these polymers alone, are not good enough to provide adequate rust protection in heavy duty applications or under extreme environmental conditions. Synthetic wax feedstocks, such has alpha-olefin waxes may be added to acrylic polymers to improve performance, however, such mixtures still do not have sufficient performance in heavy duty applications.

The disclosed technology, therefore, solves the problem of rust prevention is heavy duty applications using alpha-olefin waxes.

### SUMMARY OF THE INVENTION

Applicants found that making acrylate polymers using a synthetic wax as a diluent formed wax-acrylate polymers that were surprisingly more effective at reducing rust in heavy duty applications than compositions produced by the mere admixing of acrylate polymers and synthetic waxes. Accordingly, polymers having an acrylic-olefin backbone prepared from a monomer composition comprising at least one C₁₋₃₀ (meth) acrylic compound and at least on alpha-olefin having a chain length of at least 20 carbon atoms (a “C₂₀₊ α-olefin”) are disclosed. The resulting polymer has at least 30 wt % (or at least 35 wt %, or 40 wt %, or 45 wt %, or at least 49 or 50 wt %) of the alpha-olefin incorporated therein.

In some embodiments, the at least one (meth)acrylic compound may be a C₁₋₂₀, or C₁₋₁₈, or C₄₋₁₂, (meth)acrylate, or a mixture thereof. Suitable (meth)acrylic compounds include (meth)acrylate, (meth)acrylic acid, (meth)acrylamide, or combinations thereof. In some embodiments, the (meth)acrylic compound may be a (meth)acrylate such as, but not limited to, butyl acrylate, n-butyl methacrylate, stearyl methacrylate, methyl methacrylate, or a mixture thereof. In some embodiments, the (meth)acrylate may comprise butyl acrylate, n-butyl methacrylate or a mixture thereof. In other embodiments, the (meth)acrylate may comprise stearyl methacrylate, methyl methacrylate, or a mixture thereof.

The polymer backbone may comprise at least 30 wt % (or at least 35 wt %, or 40 wt %, or 45 wt %, or at least 49 or 50 wt %) of an alpha-olefin. In some embodiments, the polymer backbone may comprise at least 49 or 50 wt % of an alpha-olefin. Suitable alpha-olefins include, but are not limited to, a C₂₀₋₂₈ α-olefin, C₂₀₋₂₄ α-olefin, C₂₄₋₂₈ α-olefin, C₂₆₋₂₈ α-olefin, an alpha-olefin having a chain length of at least 30 carbon atoms (a “C₃₀+α-olefin”), or a mixture thereof.

In some embodiments, the at least one alpha-olefin may comprise a C₂₄₋₂₈ α-olefin. In other embodiments, the monomer composition may comprise a C₂₄₋₂₈ α-olefin and an acrylate monomer that is butyl acrylate, n-butyl methacrylate or a mixture thereof. In such embodiments, the polymer backbone may comprise at least 40 wt % or at least 50 wt % of a C₂₄₋₂₈ α-olefin.

The molecular weight of suitable polymers is not overly limited, for example, the polymer may have a weight average molecular weight Mw ranging from 10,000 to 100,000 Daltons. In some embodiments, the Mw may range from 10,000 to 80,000 or 10,000 to 75,000, or 15,000 to 70,000 Daltons.

The polymers disclosed herein are useful as rust preventatives. Accordingly, a rust preventative composition comprising any of the polymers described above is disclosed. The rust preventative composition may optionally comprise one or more of the following components: at least one detergent used at a concentration of 20 to 40 wt % and/or at least one polyisobutylene thickener used at a concentration of 0 to 20 wt %, based on a total weight of the composition. The rust preventative composition may have a corrosion performance of greater than 250 hours as measured using ASTM B117. In some embodiments the rust preventative composition may have an improved UV stability performance as measured using ASTM G154 compared to rust preventative compositions without the disclosed polymer.

Methods and uses of reducing corrosion of metal components by coating the components with a rust preventative composition comprising the polymers described above are also disclosed.

### DETAILED DESCRIPTION OF THE INVENTION

Various features and embodiments will be described below by way of non-limiting illustration. Polymers having an acrylic-olefin backbone prepared from a monomer composition comprising at least one C₁₋₃₀ (meth)acrylic compound and at least one alpha-olefin having a chain length of at least 20 carbon atoms (a “C₂₀+ α-olefin”) are disclosed.

The at least one (meth)acrylic compound may be a C₁₋₃₀, C₁₋₂₀, or C₁₋₁₈, or C₄₋₁₂, (meth)acrylic compound, or a mixture thereof. The (meth)acrylic compound may comprise at least one (meth)acrylate, (meth)acrylic acid, (meth)acrylamide, or combinations thereof. As used herein, the term “acrylic” includes derivatives of acrylic or methacrylic acids, salts, or amides. Further, the term “(meth)acrylate” and related terms includes both acrylate and methacrylate groups, ie. the methyl group is optional. Accordingly, in some embodiments, the acrylic compound may comprise at least one acrylate, acrylic acid, acrylamide, methacrylate, methacrylic acid, methacrylamide, or combinations thereof.

In yet other embodiments, the acrylic may be a (meth)acrylate having the formula (I):

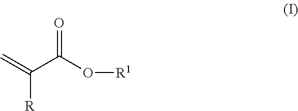

wherein R is a hydrogen or a C₁-C₃₀ hydrocarbyl group and R¹ is a C₁-C₃₀ hydrocarbyl group. Additional ranges for either R or R¹ include, C₁₋₂₀, or C₁₋₁₈, or C₄₋₁₂ hydrocarbyl groups. In another embodiment, R may be a hydrogen or a methyl group and R¹ may be a C₁₋₂₀, or C₁₋₁₈, or C₄₋₁₂ hydrocarbyl group.

As used herein, the term “hydrocarbyl” refers to a group having a carbon atom directly attached to the remainder of the molecule, where the group includes at least carbon and hydrogen atoms. If the hydrocarbyl group comprises more than one carbon atom, then those carbons need not necessarily be linked to each other. For example, at least two of the carbons may be linked via a suitable element or group. In various embodiments, the term “hydrocarbyl” refers to a group having a carbon atom directly attached to the remainder of the molecule, where the group consists of carbon, hydrogen, optionally one or more heteroatoms provided the heteroatoms do not alter the predominantly hydrocarbon nature of the substituent. The heteroatom may link at least two of the carbons in the hydrocarbyl group, and optionally no more than two non-hydrocarbon substituents. Suitable heteroatoms will be apparent to those skilled in the art and include, for instance, sulphur, nitrogen, oxygen, phosphorus and silicon. Where the hydrocarbyl contains heteroatoms, optionally, no more than two heteroatoms will be present for every ten carbon atoms in the hydrocarbyl group. Suitable non-hydrocarbon substituents will also be apparent to those skilled in the art and include, for instance, halo, hydroxy, alkoxy, mercapto, alkylmercapto, nitro, nitroso, and sulphoxy.

Examples of hydrocarbyls within the context of the present technology therefore include:
(i) hydrocarbon groups selected from aliphatic (e.g. alkyl or alkenyl), alicyclic (e.g. cycloalkyl, cycloalkenyl, cycloalkadienyl), and aromatic groups;
(ii) substituted hydrocarbon groups, selected from hydrocarbon groups defined in (i) substituted with no more than two non-hydrocarbon substituents and/or one or more hydrocarbon substituents, the non-hydrocarbon substituents being selected from the group consisting of halo, hydroxy, alkoxy, mercapto, alkylmercapto, nitro, nitroso, and sulphoxy;
(iii) hetero-containing hydrocarbon groups, selected from hydrocarbon groups defined in (i) containing one or more heteroatom in the ring or chain, provided that the group has no more than two heteroatoms present for every ten carbon atoms in the group, the heteroatoms being selected from sulphur, nitrogen, oxygen, phosphorus and silicon. The hetero-containing hydrocarbon groups may be substituted with no more than two non-hydrocarbon substituents and/or one or more hydrocarbon substituents.

In some embodiments, the term “hydrocarbyl” refers to a group having carbon atoms directly attached to the remainder of the molecule, where the group consists of carbon and hydrogen atoms.

Suitable (meth)acrylates include, but are not limited to, methyl (meth)acrylate, ethyl (meth)acrylate, propyl (meth)acrylate, butyl (meth)acrylate, 2-methylpentyl (meth)acrylate, 2-propylheptyl (meth)acrylate, 2-butyloctyl (meth)acrylate, 2-ethylhexyl (meth)acrylate, octyl (meth)acrylate, nonyl (meth)acrylate, isooctyl (meth)acrylate, isononyl (meth)acrylate, 2-tert-butylheptyl (meth)acrylate, 3-isopropylheptyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylhepta-decyl (meth)acrylate, 4-tert-butyloctadecyl (meth)acrylate, 5-ethyloctadecyl (meth)acrylate, 3-isopropyl octadecyl-(meth)acrylate, octadecyl (meth)acrylate, nonadecyl (meth)acrylate, eicosyl (meth)acrylate, (meth)acrylates derived from unsaturated alcohols, such as oleyl (meth)acrylate; and cycloalkyl (meth)acrylates, such as 3-vinyl-2-butylcyclohexyl (meth)acrylate or bornyl (meth)acrylate.

In some embodiments, (meth)acrylates include, but are not limited to, butyl acrylate, n-butyl methacrylate, stearyl methacrylate, methyl methacrylate, or a mixture thereof. In some embodiments, the monomer composition may comprise butyl acrylate, n-butyl methacrylate or a mixture thereof. In other embodiments, the at least one (meth)acrylate may comprise stearyl methacrylate, methyl methacrylate, or a mixture thereof.

Other examples of suitable (meth)acrylates include alkyl (meth)acrylates with long-chain alcohol-derived groups which may be obtained, for example, by reaction of a (meth)acrylic acid (by direct esterification) or methyl (meth)acrylate (by transesterification) with long-chain fatty alcohols, in which reaction a mixture of esters such as (meth)acrylate with alcohol groups of various chain lengths is generally obtained. These fatty alcohols include Nafol® 1620, Alfol® 10, Alfol® 810, Alfol® 12, Alfol® 1012EE, Alfol® 1014CDC, Alfol® 1214, Alfol® 1214GC, Alfol® 1214HA, Alfol® 1216, and Lial® 125 of Sasol; Neodol® 91, Neodol® 23, Neodol® 25, Neodol® 45 and Neodol® 135 of Shell AG; C13-C15 Alcohol, Isotridecanol, Hydrenol® and Lorol® of BASF; Kalcol® 2465, Kalcol® 2470, Kalcol® 8655 of Kao Corporation, as well as Econol® 80, Econol® 24, Econol® 26, Econol® 28, and Econol® 68 of Ecogreen Oleochemicals.

Further examples of (meth)acrylates include alkyl (methacrylates) with branched chain alcohol-derived groups which may be obtained, for example, by reaction of a (meth)acrylic acid (by direct esterification) or methyl (meth)acrylate (by transesterification) with Guerbet alcohols. Examples of Guerbet alcohols include 2-butyloctanol, 2-butyldecanol, 2-hexyloctanol, 2-hexyldecanol, 2-octyldecanol, 2-hexyldodecanol, 2-octyldodecanol, 2-decyltetradecanol, 2-dodecylhexadecanol, and 2-tetradecyloctadecanol.

The (meth)acrylates, may be aromatic including, for example, benzyl methacrylate. In another embodiment, the aromatic (meth)acrylates may be selected from phenyl methacrylate, phenylpropyl methacrylate or styrene. It is contemplated that other oil insoluble (meth)acrylates that are polymerizable in oil may also be used. Mixtures of these and other oil insoluble monomers may also be used to make the disclosed polymers.

In one embodiment, suitable (meth)acrylates may comprise a dispersant monomer; dispersant monomers include those monomers which may polymerize with (meth)acrylate monomers and contain one or more heteroatoms in addition to the carbonyl group of the (meth)acrylate. The dispersant monomer may contain a nitrogen-containing group, an oxygen-containing group, or mixtures thereof.

In some embodiments, the (meth)acrylic compound may be a (meth)acrylic acid or an oxygen containing (meth)acrylate monomer. The (meth)acrylic acid may comprise an acrylic acid having the formula (II):

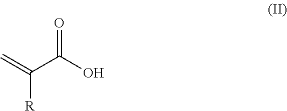

wherein R may be a hydrogen or a C₁-C₃₀ hydrocarbyl group.

The oxygen-containing compound may include hydroxyalkyl (meth)acrylates such as 3-hydroxypropyl (meth)acrylate, 3,4-dihydroxybutyl (meth)acrylate, 2-hydroxyethyl(meth)acrylate, 2-hydroxypropyl (meth)acrylate, 2,5-dimethyl-1,6-hexanediol (meth)acrylate, 1,10-decanediol (meth)acrylate, carbonyl-containing (meth)acrylates such as 2-carboxyethyl (meth)acrylate, carboxy methyl (meth)acrylate, oxazolidinylethyl (meth)acrylate, N-(methacryloyloxy) formamide, acetonyl (meth)acrylate, N-methacryloylmorpholine, N-methacryloyl-2-pyrrolidinone, N-(2-methacryloyl-oxyethyl)-2-pyrrolidinone, N-(3-methacryloyl oxypropyl)-2-pyrrolidinone, N-(2-methacryloyl oxypentadecyl)-2-pyrrolidinone, N-(3-methacryloyloxy-heptadecyl)-2-pyrrolidinone; glycol di(meth)acrylates such as 1,4-butanediol (meth)acrylate, 2-butoxyethyl(meth)acrylate, 2-ethoxyethoxymethyl(meth)acrylate, 2-ethoxyethyl (meth)acrylate, or mixtures thereof.

In some embodiments, the (meth)acrylic compound may be a (meth)acrylamide or a nitrogen containing (meth)acrylate monomer. The (meth)acrylamide may comprise an acrylamide having the formula (III):

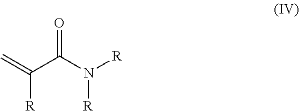

wherein each R may be a hydrogen or a C₁-C₃₀ hydrocarbyl group.

Examples of a suitable nitrogen-containing compound include N,N-dimethylacrylamide, N-vinyl carbonamides such as N-vinyl-formamide, vinyl pyridine, N-vinylacetoamide, N-vinyl propionamides, N-vinyl hydroxy-acetoamide, N-vinyl imidazole, N-vinyl pyrrolidinone, N-vinyl caprolactam, N-vinyl furan, vinyl oxazole, N,N-dimethylaminoethyl (meth)acrylate, N,N-dimethylaminopropyl (meth)acrylate, N,N-diethylaminoethyl(meth)acrylate, 2-diisopropylaminoethyl(meth)acrylate, 2-t-butylaminoethyl (meth)acrylate, N-2-dimethylaminoethyl(meth)acryl amide, N-3-dimethylaminopropyl (meth)acrylamide N,N-dimethylaminobutyl(meth)acryl amide, N-2-diethylaminoethyl (meth)acrylamide or mixtures thereof.

The (meth)acrylates as described above may be reacted with alpha-olefins to produce a polymer. In some embodiments, the at least one (meth)acrylate is a single chemical species. In yet other embodiments, blends of one or more of the (meth)acrylates described above may be used.

The alpha-olefins (sometimes referred to as mono-1-olefins) used to make the polymer may include isomerized alpha-olefins. Examples of suitable alpha-olefins include ethylene, propylene, butylene, 1-octene, 1-nonene, 1-decene, 1-dodecene, 1-tridecene, 1-tetradecene, 1-pentadecene, 1-hexadecene, 1-heptadecene, 1-octadecene, 1-nonadecene, 1-eicosene, 1-henicosene, 1-docosene, 1-tetracosene, etc. Commercially available alpha-olefin fractions that may be used include those that are “waxier” in natures and generally include alpha-olefin cuts that have 20 or more carbon atoms (C₂₀+α-olefins), for example, C₂₀₋₂₈ α-olefins, C₂₀₋₂₄ α-olefins, C₂₄₋₂₈ α-olefins, C₂₆₋₂₈ α-olefins, an alpha-olefin having a chain length of at least 30 carbon atoms (a “C₃₀+α-olefin”), or a mixture thereof. Production of these types of alpha-olefins are well known in the industry. Exemplary alpha-olefins that are commercially available include AlphaPlus® alpha-olefins produced by Chevron Phillips Chemical Company, LP.

In some embodiments, the monomer composition may comprise a C₂₄₋₂₈ α-olefin. In other embodiments, the monomer composition may comprise a C₂₄₋₂₈ α-olefin and an acrylate monomer that is butyl acrylate, n-butyl methacrylate or a mixture thereof. In such embodiments, the polymer backbone may comprise at least 40 wt % or at least 50 wt % of a C₂₄₋₂₈ α-olefin.

In some embodiments, a third monomer may be used to prepare the acrylic-olefin polymers that is suitable as a rust preventative, so long as the resulting polymer has a primarily acrylic-olefin backbone with at least 30 wt % (or at least 35 wt %, or 40 wt %, or 45 wt %, or at least 49 or 50 wt %) of the alpha-olefin incorporated therein. Suitable third monomers are not overly limited and include any monomer that readily reacts with the (meth)acrylic compound and the alpha-olefin. In some embodiments, the third monomer may be present in the monomer composition from 0.1 to 10 wt %, from 0.1 to 8 wt %, from 0.5 to 6 wt %, and from 0.5 to 5 wt %.

The molecular weight of suitable polymers is not overly limited and can include any molecular weight suitable for use in coating applications. Accordingly, in some embodiments, the polymer may have a weight average molecular weight Mw ranging from 10,000 to 100,000 Daltons. In some embodiments, the Mw may range from 10,000 to 80,000 or 10,000 to 75,000, or 15,000 to 70,000 Daltons.

The weight average molecular weight of the materials described herein is measured using gas permeation chromatography (GPC) using a Waters GPC 2000 equipped with a refractive index detector and Waters Empower™ data acquisition and analysis software. The columns are polystyrene (PLgel, 5 micron, available from Agilent/Polymer Laboratories, Inc.). For the mobile phase, individual samples are dissolved in tetrahydrofuran and filtered with PTFE filters before they are injected into the GPC port.

### Waters GPC 2000 Operating Conditions:

Injector, Column, and Pump/Solvent compartment temperatures: 40° C.
Autosampler Control: Run time: 40 minutes
Injection volume: 300 microliter
Pump: System pressure: ˜ 90 bars (Max. pressure limit: 270 bars, Min. pressure limit: 0 psi)
Flow rate: 1.0 ml/minute
Differential Refractometer (RI): Sensitivity: −16; Scale factor: 6

The polymers disclosed herein are useful as rust preventatives. The rust preventative compositions may be used at 100% actives, or they may be a dilution. As used herein, “dilution” is weight percent on an active basis, for example, 60 wt % dilution would have 60 wt % actives and 40 wt % diluent. The rust preventative compositions may be diluted for example to 60 wt %, 50 wt %, or 40 wt % dilution. Accordingly, in some embodiments the dilution may be between 40 wt % to 60 wt % or 50 wt % to 60 wt % dilution. In yet other embodiments the dilution may be between 40 wt % and 50 wt % dilution, for example, 41 wt %, 42 wt %, 43, wt %, 44 wt %, 45 wt %, 46 wt %, 47 wt %, 48 wt %, or 49 wt % dilution. Accordingly, a rust preventative composition comprising any of the polymers described above is disclosed, which may or may not be diluted as described above.

Suitable diluents include mineral spirits with a flash point of 60 C. In some embodiments, rust preventative composition may also optionally contain a volatile diluent. By “volatile diluent” is meant a normally liquid component that has a volatility greater than that of an oil such as mineral oil. The volatile diluent may comprise water or one or more organic solvents. The diluent may thus comprise a volatile organic solvent such as naphtha (also known as petroleum ether), mineral spirits, kerosene, or ethyl lactate. Among these materials may be hydrocarbon solvents. Such materials may have a boiling point of 30 to 60° C. or higher temperatures, up to a range of 175 to 280° C. Some such volatile diluents may have a boiling range of 130-210° C.; others 196-205° C. Overall, a diluent may be considered volatile if its boiling point is less than 280° C.

The volatile diluent may be present in a concentrate of the foregoing components, if desired, although most commonly the diluent, or the majority of the diluent will be added in preparing the fully formulated, diluted rust preventative composition. The amount of diluent will typically be an amount to provide for appropriate viscosity and rheological performance so that the rust preventative composition may be applied to a substrate such as a metallic article or surface. Thus, if the concentrate is diluted to 40 percent in the final coating composition, the total amount of diluent will typically 60 percent additional solvent or diluent to make the dilution (in addition to the oil dissolving the metal salt, which is not counted toward the amount of the volatile diluent). The overall total amount of the diluent (if present) will depend, of course, on the amount of diluent used to prepare the final rust preventative composition and so may be present at 60 wt %, 50 wt %, or 40 wt %, based on the total weight of the rust preventative composition. The amount of the other components will typically be 100% by weight less the amount of the optional volatile diluent, such as at least 40 to 60 weight percent or greater and other amounts that may be readily determined by the skilled person.

That is, one of the ways in which the present technology may be employed is by preparing an initial mixture of the components described herein, without the presence of the optional volatile diluent, or with its presence only in small amounts such as up to 10 percent or 5 percent or 2 percent or 1 percent or 0.1 percent by weight of the composition. For this reason, the amounts of the other components may be expressed as a percentage of the composition exclusive of the amount of the optional volatile diluent. It is in this form (volatile diluent- or solvent-free) that the materials of the disclosed technology may often be commercially prepared and distributed. However, the diluent-free material may have a viscosity that is unsuitable for easy handling, so addition of a volatile diluent may be desirable before the composition is applied as a coating to a substrate. If, at the time of application of the coating, a diluent is present, then the actual amounts of the other components can be calculated to take into account the presence of the diluent.

In some embodiments, the rust preventative composition may optionally comprise one or more of the following components: at least one detergent in amounts ranging from 20 to 40 wt % and/or at least one thickener in amounts ranging from 0 to 20 wt %, based on a total weight of the rust preventative composition.

The detergent may comprise at least one phenate, salicylate, salixarate, sulfonate, or combinations thereof. In some embodiments, the detergent is a sulfonate detergent. The sulfonate may typically be a salt of an alkylarylsulfonate having one or more hydrocarbyl or alkyl groups of sufficient length to provide solubility in a hydrocarbon oil. The salt may be a metal salt or, alternatively, a non-metal salt such as an amine (or ammonium) salt. The “sufficient length” may be at least 12 carbon atoms and up to 200 carbon atoms, such as 18 to 100 or 24 to 48 carbon atoms in the combined alkyl or hydrocarbyl groups or, alternatively, in the longest of such groups if there is more than one. In one embodiment, each hydrocarbyl or alkyl group may individually contain at least 8 or at least 12 carbon atoms, and up to 200 carbon atoms, or 18 to 100 or 24 to 48. Examples of sulfonate salts include relatively low molecular weight salts such as calcium mono-, di-, or tri-nonyl naphthalene sulfonate (or mixtures of mono-, di-, and tri-alkyl species) and relatively higher molecular weight salts such as calcium oligo- or poly-propene benzenesulfonates or -toluenesulfonates.

These may be neutral salts or overbased salts. Neutral salts are those that contain approximately or exactly a stoichiometric amount of metal ion to neutralize the acid functionality of the alkarylsulfonic acid. Overbased salts are prepared by reaction with a stoichiometric excess of metal, such as calcium, barium, magnesium, potassium, zinc, or sodium, in the form of a basic compound such as, in the case of calcium, the oxide, hydroxide or, ultimately, the carbonate as a result of treatment with carbon dioxide. Accordingly, in some embodiments, the metal detergent may be a metal overbased detergent. Overbased materials are well known in the lubricant industry as overbased detergents and may also function as surfactants or wetting agents. In certain embodiments, the salt may be a calcium, barium, or sodium salt. In yet other embodiments the salt may be a calcium or magnesium salt. The TBN of the metal detergent may range from 15 to 500 mg KOH/g, or 25 to 400 mg KOH/g. TBN is an expression frequently used to describe the basicity of lubricant additives and/or lubricants. It is the amount of potassium hydroxide (mg KOH) needed to neutralize one gram of the sample being tested using titration and bromophenol blue as in indicator. Such TBN titration methods are well known in the art and have been standardized in the industry such as in ASTM D2896.

In some embodiments, the metal sulfonate may be a salt of an alkarylsulfonic acid that contains an alkyl group of 9 to 200, or 12 to 200, or 18 to 100, or 25 to 50, or 30 to 40 carbon atoms. Such materials are typically provided in commercial form in the presence of an amount of a diluent oil, typically a mineral oil such as an API Group I oil, in which they are often prepared. The amount of diluent oil that may be associated with and accompany the metal alkylarylsulfonate salt may be in the ratio of 1:5 to 5:1 of the salt to oil. Accordingly, in some embodiments, the metal detergent may be a calcium sulfonate detergent. The calcium sulfonate detergent may be neutral or overbased. In yet other embodiments, the metal detergent is an overbased calcium sulfonate detergent.

The amount of the detergent (for example a metal sulfonate) in the disclosed rust preventative composition may range from 2 to 30 percent by weight, or 3 to 30, or 3 to 25, or 4 to 20, or 5 to 15 percent by weight, on an oil-free basis. The quoted amounts, as above, exclude the amount of any volatile diluent that may be present. In yet other embodiments, the detergent may be present at least one detergent in amounts ranging from 20 to 40 wt %, based on the total weight of the rust preventative composition.

In some embodiments, the rust preventative composition may comprise one or more components to enhance corrosion protection. Suitable components are not overly limited and can include fatty acids, dimerized fatty acids, dicarboxylic acids, oxidized waxes, and esterified waxes.

In some embodiments, the disclosed rust preventative composition may comprise a thickener for ease of handling and improve coating adherence to metal parts. Suitable thickeners are not overly limited and can include bright stock and other high-viscosity petroleum oils, polymer thickening agents, such as polytetrafluoroethylene, polystyrenes, styrene-butadiene polymers, and olefin polymers. In some embodiments, the thickener may be a polyisobutylene thickener with a number average molecular weight of about 2000 Daltons.

The rust preventative composition may have a corrosion performance of greater than 250 hours as measured using ASTM B117. In some embodiments the rust preventative composition may have an improved UV stability performance as measured using ASTM G154 compared to rust preventative compositions without the disclosed polymer.

Methods and uses of reducing corrosion of metal components by coating the components with a rust preventative composition comprising the polymers described above are also disclosed.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

The invention herein is useful for reducing corrosion in heavy duty applications, which may be better understood with reference to the following examples.

### EXAMPLES

### Example Set 1—Acrylic Polymers Without Alpha-Olefin

Six solvent-soluble acrylics are made with mixtures of stearyl methacrylate (to provide solvent solubility) and other acrylic monomers and are functionalized with small amounts of methacrylic acid or 3-dimethyl aminopropyl methacrylamide (DMAPMA). The acrylate polymers are synthesized at 60 wt % activity in Exxsol 60D, a dearomatized hydrocarbon solvent. The compositions used to make the acrylate polymers are shown in Table 1 below. Amounts shown are percent by weight (wt %).

TABLE 1
Acrylate Polymer Compositions

| Monomer Mixture (wt %) | Comp 1 | Comp 2 | Comp 3 | Comp 4 | Comp 5 | Comp 6 |
|---|---|---|---|---|---|---|
| Stearyl methacrylate | 48 | 42 | 42 | 48 | 42 | 42 |
| Methyl methacrylate | 9 | | | 9 | | |
| Lauryl methacrylate | | 15 | | | 15 | |
| C32 Guerbet alcohol | | | 15 | | | 15 |
| Methacrylic acid | 3 | 3 | 3 | | | |
| DMAPMA | | | | 3 | 3 | 3 |
| Exxsol D60 | 40 | 40 | 40 | 40 | 40 | 40 |

The resulting acrylic polymers are then blended with 10 wt % of a C₂₄ to C₂₈ alpha-olefin. and evaluated for corrosion performance to determine whether the alpha olefin could provide sufficient waxiness to give a strong protective coating. Polymer/olefin blends are shown in Table 2 below along with their salt spray performance using the ASTM B117-Standard Practice for Operating Salt Spray (Fog) Apparatus. In this method, polymer coatings were drawn down to a specified thickness on AISI 1008 carbon steel Q panels (available from Q-Lab Corporation) and allowed to dry for 24 hours. Panels were then placed in a salt fog chamber held at a temperature of 35° C. with a 5% NaCl solution sprayed continually. A panel was considered a failure when greater than 5% rust appeared on the surface. None of the blends in Table 2 provided the salt spray performance for the recommended protection of a heavy-duty product.

TABLE 2
Acrylate polymer/alpha olefin blends

| Blend | Comp 1A | Comp 2A | Comp 3A | Comp 4A | Comp 5A | Comp 6A |
|---|---|---|---|---|---|---|
| Polymer used | Comp 1 | Comp 2 | Comp 2 | Comp 3 | Comp 5 | Comp 6 |
| Polymer wt % | 90 | 90 | 90 | 90 | 90 | 90 |
| C₂₄₋₂₈ AO wt % | 10 | 10 | 10 | 10 | 10 | 10 |
| Salt spray | 56 | 80 | 152 | 20 | 20 | 0 |
| Avg hrs to fail | | | | | | |

### Example Set 2—Acrylic-Olefin Hybrid Polymers

### Polymer Synthesis

The disclosed acrylate/alpha-olefin polymer may be prepared by melting the alpha-olefin and adding it to a 4-neck, round-bottom flask equipped with a mechanical stirrer, nitrogen inlet, thermocouple, and Claisen adapter with peristaltic pump tube inlet and water-cooled condenser. The (meth)acrylate is pre-mixed with an initiator (tert-butyl peroxy-2-ethylhexanoate or tert-butyl peroxybenzoate) and then fed into the flask via a peristaltic pump over approximately 4 hours. Once the feed is complete, the reaction is held between 9° and 125° C. for 3 about hours. The resulting polymers are colorless solids that melt around 48 to 53° C. This method may be modified and/or optimized by those ordinarily skilled in the art depending on reaction conditions, equipment, or raw materials, etc. to prepare the desired polymer, namely a polymer having a backbone comprising at least 30 wt % (or at least 35 wt %, or 40 wt %, or 45 wt %, or at least 49 or 50 wt %) of an alpha-olefin.

Various polymers were synthesized using the above method. They were readily diluted to 60% and 40% in Exxsol™ D60 solvent. The dilutions were stable for over a month when stored at room temperature. The dilutions were also evaluated for corrosion performance using the ASTM B117 salt spray method. The dilutions at a 60% treat rate were soft solids that could be easily drawn down on a metal panel to a thickness of 8 mils wet. The dilutions at a 40% treat rate were thin liquids that required dipping. Table 3 shows the synthesized polymer compositions and the 60% and 40% dilution salt spray results.

TABLE 3
Acrylic-olefin Hybrid Polymers and Salt Spray Results

| Component (wt %) | Ex 1 | Ex 2 | Ex 3 | Ex 4 | Ex 5 | Ex 6 | Ex 7 |
|---|---|---|---|---|---|---|---|
| C₂₄-C₂₈ α-olefin | 56.97 | 56.97 | 56.97 | 56.97 | 56.97 | 75.96 | 56.97 |
| Butyl acrylate | 37.98 | 37.98 | 37.98 | | | 18.99 | |
| N-butyl methacrylate | | | | 37.98 | | | |
| Stearyl methacrylate | | | | | 31.81 | | 30.38 |
| Methyl methacrylate | | | | | 6.17 | | 5.70 |
| Methacrylic acid | | | | | | | 1.90 |
| Initiator | 5.05 | 5.05 | 5.05 | 5.05 | 5.05 | 5.05 | 5.05 |

Resulting Polymer Composition (wt %)

| | | | | | | | |
|---|---|---|---|---|---|---|---|
| C₂₄-C₂₈ α-olefin | 51.59 | 51.59 | 52.61 | 32.96 | 37.79 | 67.95 | 37.38 |
| Acrylate | 48.41 | 48.41 | 47.39 | 67.04 | 52.10/ | 32.05 | 50.09/ |
| | | | | | 10.11 | | 9.40/3.13 |

GPC Results

| | | | | | | | |
|---|---|---|---|---|---|---|---|
| M_{w} | 22,058 | 31,082 | 40,813 | 16,747 | 15,681 | 13,216 | 18,526 |
| Mₙ | 5,712 | 10,501 | 12,013 | 7,741 | 7,233 | 7,111 | 8,263 |
| PDI | 3.86 | 2.95 | 3.39 | 2.16 | 2.17 | 1.86 | 2.24 |

ASTM B117 Salt Spray Results

| | | | | | | | |
|---|---|---|---|---|---|---|---|
| Salt spray, 60% | 848 | 540 | 920+ | 920+ | 748 | 656+ | 192 |
| dilution (60% | | | | | | | |
| actives) | | | | | | | |
| Avg hrs to fail | | | | | | | |
| Salt spray, 40% | 772 | 24 | 0 | 16 | 0 | 0 | 0 |
| dilution (40% | | | | | | | |
| actives) | | | | | | | |
| Hours to fail | | | | | | | |

The polymers perform significantly better than the acrylate polymer/alpha olefin blends of Table 2. The polymers do not perform as well at a lower treat rate, likely due to the thinness of the coating.

Scale-up batches of polymers are prepared, and their performance salt spray performance are tested at various dilutions. The polymer compositions and performance results or the scale-up batches are shown in Table 4 below.

TABLE 4
Acrylic-olefin Hybrid Polymers and Salt Spray Results

| Component (wt %) | Ex 8 | Ex 9 |
|---|---|---|
| C₂₄-C₂₈ α-olefin | 58.94 | 59.70 |
| Butyl acrylate | 39.29 | 39.80 |
| Initiator | 1.77 | 0.50 |

Resulting Polymer Composition (wt %)

| | | |
|---|---|---|
| C₂₄-C₂₈ α-olefin | 55.21 | 49.04 |
| Acrylate | 44.79 | 50.96 |

GPC Results

| | | |
|---|---|---|
| M_{w} | 65,630 | 28,470 |
| Mₙ | 10,363 | 10,242 |
| PDI | 6.33 | 2.78 |

ASTM B117 Salt Spray Results

| | | |
|---|---|---|
| Salt spray, 60% dilution | 1000+ | 1000+ |
| Average hours to fail | | |
| Salt spray, 50% dilution | 1000+ | 1000+ |
| Average hours to fail | | |
| Salt spray, 40% dilution | 8 | 8 |
| Average hours to fail | | |
| Salt spray, 30% dilution | 8 | 8 |
| Average hours to fail | | |

As shown in Table 4 above, the polymers perform extremely well at 60 and 50 wt % dilution, with a significant drop at 40 wt % dilution. An optimal actives concentration is likely somewhere between 40 wt % and 50 wt % dilution, for example, 41 wt %, 42 wt %, 43, wt %, 44 wt %, 45 wt %, 46 wt %, 47 wt %, 48 wt %, or 49 wt % dilution.

UV stability is an important factor for heavy-duty rust preventives, as the coatings are typically used for outdoor corrosion protection in the elements. To assess UV stability, coatings are drawn down to a thickness of 8 mils wet on AISI 1008 carbon steel panels (available from Q-Lab Corporation) and allowed to dry for 24 hours. Once the coatings have dried, the panels are exposed to ultraviolet light with a wavelength of 340 nm according to the ASTM G154 Cycle A method (8 hours of UV exposure followed by 4 hours of darkness and condensation), which approximates the UV energy and intensity coatings would face at high noon for 16 hours a day.

Three alpha-olefin acrylate polymers (Ex 3, Ex 8, and Ex 9) were evaluated alongside Alox® 606-55 (“AX60655”) for UV stability. AX60655 is a commercially available calcium sulfonate diluted in mineral oil that is used as a heavy-duty rust preventative. One of the Ex 8 panels failed at 552 hours and was removed; however, the remaining panels were removed after 672 hours of exposure. The panels coated with the alpha-olefin acrylate polymer dilutions showed less rust and discoloration than those coated with AX60655, indicating that alpha-olefin acrylate polymers can meet and potentially exceed the performance of traditional heavy-duty rust preventives under conditions of severe UV exposure. The results are shown in Table 5 below.

TABLE 5

| | Ex 3 | Ex 8 | Ex 9 | AX60655 |
|---|---|---|---|---|
| Dilution | 60 | 60 | 60 | 55 |
| UV stability | 672+ | 552 | 672+ | 672+ |
| Hours to fail | | 672+ | | |
| Visual rust/ | Spots | Spots | Small spots | ~100% of |
| discoloration | on ~50% of | on ~40% of | on ~30% of | surface |
| | surface | surface | surface | |

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A polymer having an acrylic-olefin backbone prepared from a monomer composition comprising:
a. at least one C₄₋₁₂ (meth)acrylic compound; and
b. at least one alpha-olefin that is a C₂₀₋₂₈ α-olefin, C₂₀₋₂₄ α-olefin, C₂₄₋₂₈ α-olefin, C₂₆₋₂₈ α-olefin, an alpha-olefin having a chain length of at least 30 carbon atoms (a “C₃₀₊ α-olefin”), or a mixture thereof; and
wherein the resulting polymer has at least 40 wt % of the alpha-olefin incorporated therein, and
wherein the polymer has a weight average molecular weight Mw ranging from 10,000 to 100,000 Daltons.

2. (canceled)

3. The polymer of claim 1, wherein the at least one (meth)acrylic compound is (meth)acrylate, (meth)acrylic acid, (meth)acrylamide, or combinations thereof.

4. The lubricating composition of claim 1, wherein the at least one (meth)acrylic compound is acrylic acid, acrylamide, methacrylate, methacrylic acid, methacrylamide, or combinations thereof.

5. The polymer of claim 1, wherein the at least one (meth)acrylic compound is a (meth)acrylate comprising butyl acrylate, n-butyl methacrylate, stearyl methacrylate, methyl methacrylate, or a mixture thereof.

6. The polymer of claim 5, wherein the (meth)acrylate comprises butyl acrylate, n-butyl methacrylate or a mixture thereof.

7. The polymer of claim 5, wherein the (meth)acrylate comprises stearyl methacrylate, methyl methacrylate, or a mixture thereof.

8. The polymer of claim 1, wherein the at least one alpha-olefin is a C₂₄₋₂₈ α-olefin, C₂₆₋₂₈ α-olefin, an alpha-olefin having a chain length of at least 30 carbon atoms (a “C₃₀₊ α-olefin”), or a mixture thereof.

9. The polymer of claim 1, wherein the at least one alpha-olefin is a C₂₄₋₂₈ α-olefin.

10. The polymer of claim 9, wherein the polymer backbone comprises at least 45 wt % of a C₂₄₋₂₈ α-olefin.

11. (canceled)

12. A rust preventative composition comprising the polymer of claim 1 and one or more of the following components:
a. at least one detergent; and/or
b. at least one polyisobutylene thickener.

13. The rust preventative composition of claim 12, wherein the at least one detergent is present between 20 and 40 wt %, based on a total weight of the composition.

14. The rust preventative composition of claim 13, wherein the detergent is a salt of an alkylarylsulfonate.

15. The rust preventative composition of claim 12, wherein the at least one polyisobutylene thickener is present between 0 and 20 wt %, based on a total weight of the composition.

16. The rust preventative composition of claim 12, wherein said rust preventative composition has a corrosion performance of greater than 250 hours as measured using ASTM B117.

17. The rust preventative composition of claim 12, wherein said rust preventative composition has an improved UV stability performance as measured using ASTM G154 compared to rust preventative compositions without the polymer.

18. A method of reducing corrosion of a metal component, said method comprising coating the metal component with the rust preventative composition of claim 12.

19. (canceled)
